(19) United States
(12) Patent Application Publication
(10) Pub. No.: US 2017/0364929 A1
(43) Pub. Date: Dec. 21, 2017

(54) METHOD AND SYSTEM FOR IDENTIFYING, AGGREGATING & TRANSFORMING EMOTIONAL STATES OF A USER USING A TEMPORAL PHASE TOPOLOGY FRAMEWORK

(71) Applicant: Sanjiv Ferreira, Mumbai (IN)

(72) Inventor: Sanjiv Ferreira, Mumbai (IN)

(21) Appl. No.: 15/406,672

(22) Filed: Jan. 14, 2017

(30) Foreign Application Priority Data
Jun. 17, 2016 (IN) 201621020769

(51) Int. Cl. G06Q 30/02; G06T 15/00; G06T 11/20

(52) U.S. Cl. CPC G06Q 30/0201; G06T 11/206; G06T 15/00

(57) ABSTRACT

The invention provides a method and system for identifying, aggregating and transforming emotional states of a user using a temporal phase topology framework. Firstly, the method captures an emotional state of the user through one of a direct selection, a combination of sensors and one or more digital assets. The method, then, determines an emotional phase state corresponding to the emotional state of the user by performing a valence assessment, a phase assessment and a composite assessment of the captured emotional state. Thereafter, the method either aggregates a group of emotional phase states captured over a period of time to determine a medial emotional phase state or transforms the emotional phase state to a target emotional phase state and provides one or more recommendations or suggestions based on a selection of a stimulus categorized in accordance with the temporal phase topology framework corresponding to the target emotional phase state.

### FIELD OF THE INVENTION

The invention generally relates to the field of user motivated voluntary identification, aggregation and transformation of emotional states using a temporal phase topology framework. More specifically, the invention relates to a method and system for a voluntary identification, aggregation and transformation of emotional states using a temporal phase topology framework by determining emotional phase states corresponding to the emotional states of the user.

### BACKGROUND OF THE INVENTION

Users consume products based on a combination of need, availability, visibility and product appeal. In order to balance consumption across the entire spectral needs of users, manufacturers provide the users with a wide variety of products. In case of food products, the food products are categorized based on proteins, carbohydrates, fats, etc. for facilitating balance consumption across the entire nutritional needs of the user.

Most other retail products consumed (including digital assets) are presented in standard product categories as either unbranded or marketed, using emotional messages in order to drive increased consumption. This emotional marketing may sometimes not be congruent to the actual emotional or energetic impact of the product being consumed. Hence, there is a need to categorize retail products consumed based on a more coherent framework taking into account the nature of their emotional or energetic impact as derived from stimuli such as, but not limited to mental, auditory, tactile, kinesthetic, olfactory, visual and gustatory stimuli. The invention recommends a uniform framework for categorization of stimuli as that used for identification of emotional states. Thus the invention aims to facilitate a more consumer centric balanced consumption by presenting a self-assessment framework for users' personal development and transformation.

Existing technologies use different frameworks or models to categorize the emotional states. While these frameworks are able to categorize most of the emotional states, they are found lacking as firstly, they do not recognize the temporal or sequencing pattern of the emotional states to permit transformation, secondly, the topology not being symmetric presents difficulties in conceptualizing user data capture and display, they do not present coherent frameworks for categorizing stimuli for effecting transformation, and lastly they do not permit aggregations of emotions over time to identify medial user tendencies.

Therefore, in light of the above, there is a need for an improved method and system for assessing and transforming emotional states of a user using a more comprehensive symmetric, coherent and temporal framework.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates a system for identifying, aggregating and transforming emotional states of a user using a temporal phase topology framework in accordance with an embodiment of the invention.

FIG. 2 illustrates an analysis module to identify an emotional phase state corresponding to an emotional state of a user in accordance with an embodiment of the invention.

FIG. 3 illustrates various display modes to capture and display an emotional phase state using a temporal phase topology framework in accordance with an embodiment of the invention.

FIG. 4 illustrates a flowchart of a method for identifying and transforming emotional states of a user using a temporal phase topology framework in accordance with an embodiment of the invention.

FIG. 5 illustrates a flowchart of a method for capturing and displaying an emotional phase state corresponding to an emotional state of a user in accordance with an embodiment of the invention.

FIG. 6 illustrates a flowchart of a method for determining a medial emotional tendencies of a user for emotional states of the user captured over a period of time using a temporal phase topology framework in accordance with an embodiment of the invention.

FIG. 7 illustrates a Lorenz Graph employed by the temporal phase topology framework as applied to emotional state vectors in accordance with an embodiment of the invention.

FIG. 8 illustrates a table of various emotional phase states associated with positions along the various sectors of the Lorenz graph employed by the temporal phase topology framework in accordance with an embodiment of the invention.

FIG. 9 illustrates a toroid representation of the phase space of the temporal phase topology framework in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and system components related to user motivated voluntary identification, aggregation and transformation of emotional states using a temporal phase topology framework.

Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article or composition that comprises a list of elements does not include only those elements but may include other elements not expressly listed or inherent to such process, method, article or composition. An element proceeded by “comprises . . . a” does not, without more constraints, preclude the existence of additional identical elements in the process, method, article or composition that comprises the element.

Various embodiments of the invention provide a method and system for user motivated voluntary identification, aggregation and transformation of emotional states using a temporal phase topology framework.

In order to identify, aggregate or transform an emotional state of a user, the method captures an emotional state of the user through one of a direct selection, a combination of sensors and one or more digital assets. The method, then, determines an emotional phase state corresponding to the emotional state of the user. The emotional phase state corresponds to a phase state location of an emotional state on the temporal phase topology framework represented by a valence coordinate and a phase coordinate. In order to determine the emotional phase state, the method performs a first assessment of the emotional state in accordance with a valence state associated with the emotional state. The valence state can be, a positive valence state and a negative valence state. The method, then, performs a second assessment of the emotional state in accordance with a phase associated with the emotional state. The method, then performs a third assessment including composite assessment corresponding to the emotion state. The method identifies the emotional phase state coordinates corresponding to the emotional state of the user based on the first assessment, second assessment and the third assessment. Thereafter, on receiving a request from the user, the method either aggregates various emotional phase states to compute the medial tendencies or transforms the emotional phase state to a target emotional phase state and provides one or more recommendations or suggestions based on a selection of a stimulus corresponding to the target emotional phase state for enabling the transformation of the emotional state of the user.

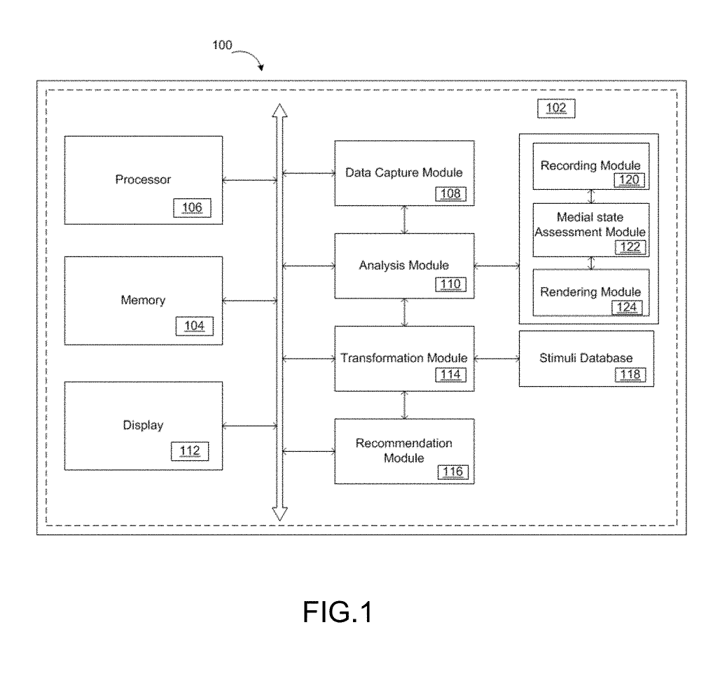

FIG. 1 illustrates a system 100 for identifying, aggregating and transforming emotional states of a user using a temporal phase topology framework 102 (also known as EmoHEAL, a product offering from the inventor of the application) in accordance with an embodiment of the invention.

As illustrated in FIG. 1, temporal phase topology framework 102 includes a memory 104 and a processor 106 communicatively coupled to memory 104.

Temporal phase topology framework 102 includes a plurality of emotional states categorized into a plurality of emotional phase states. An emotional phase state corresponds to a state location of an emotional state on the temporal phase topology framework represented by a phase coordinate and a valence coordinate.

Further, temporal phase topology framework 102 includes a data capture module 108 communicatively coupled to both memory 104 and processor 106 that captures an emotional state of the user through one of a direct selection by the user, a combination of sensors and one or more digital assets tagged with one or more emotions corresponding to the user. The one or more digital assets include multimedia objects such as, but not limited to, video files, movies, audio files, audio tracks, podcasts, audiobooks, image, photos, games and computer application programs. Further, the one or more digital assets can be accessed through one or more web hyperlinks. The one or more digital assets are then fed into a data capture module 108 that relates an emotional state based on the one or more emotions.

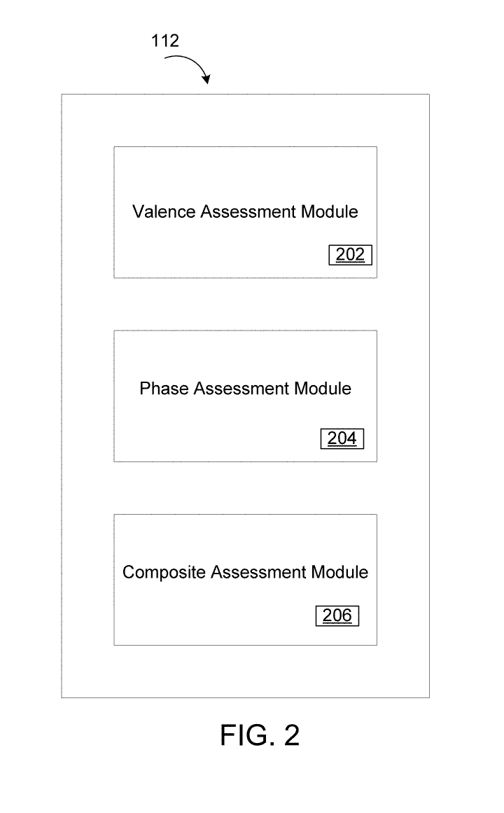

Moving on, the emotional state captured by data capture module 108 is then fed into an analysis module 110 communicatively coupled to both memory 104 and processor 106. Analysis module 110 determines an emotional phase state corresponding to the emotional state of the user by analyzing the phase and valence of the emotional states. Analysis module 110 is further described in detail in conjunction with FIG. 2.

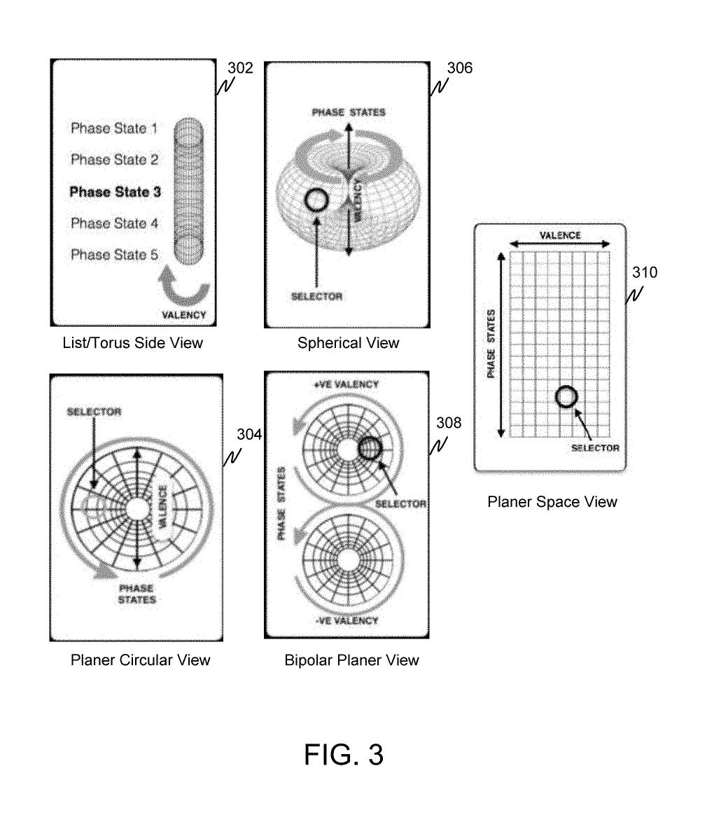

In accordance with an embodiment, data capture module 108 is used to directly capture an emotional phase state of the user corresponding to an emotional state by rendering a plurality of emotional states and a valence corresponding to each emotional state of the plurality of emotional states in a plurality of display modes using a display 112 of temporal phase topology framework 102. A display mode can be, but need not be limited to, a list/toroid side view, a planer map view, a spherical view, a bipolar planer view and a planer space view. The different display modes used to capture and display the emotional state of the user are further described in detail in conjunction with FIG. 3.

Data capture module 108, then, enables the user to select an emotional state of the plurality of the emotional states along with the valence corresponding to the emotional state using display 112 to capture the emotional phase state.

The emotional phase state, thus determined, is then fed into a transformation module 114 communicatively coupled to both memory 104 and processor 106. Transformation module 114 transforms the emotional phase state to a target emotional phase state using the temporal properties of temporal phase topology framework 102. Based on the target emotional phase state, a recommendation module 116 communicatively coupled to both memory 104 and processor 106 selects one or more stimuli from a stimuli database 118. Stimuli database 118 comprises a plurality of stimuli that are categorized into phase states in accordance with temporal phase topology framework 102. Each stimulus can be, but need not be limited to, a mental, an auditory, a tactile, a kinesthetic, an olfactory, a visual and a gustatory input. In order to select a specific stimulus from stimuli database 118, recommendation module 116 compares the phase states corresponding to the stimuli and the target emotional phase state. Recommendation module 116, then, selects a stimulus corresponding to a phase state to achieve the target emotional phase state.

After a selection of the stimulus, the stimulus option is presented to the user through at least one of a visual input and an auditory input. Further, recommendation module 116 provides the selected stimulus to the user by recommending one or more activities that the user may perform corresponding to the stimulus. Thus, recommending the one or more activities corresponding to the selected stimulus allows the user to move towards a greater emotional balance.

Further, temporal phase topology framework 102 also enables the user to provide a feedback based on an experience of the stimulus to adjust the one or more phase states of the stimulus to provide an effective categorization of the stimulus.

In accordance with another embodiment, analysis module 110 analyses and determines a plurality of emotional phase states corresponding to emotional states of the user captured over a time period. The plurality of emotional phase states are recorded using a recording module 120. From recording module 120, the plurality of emotional phase states are fed into a medial state assessment module 122.

Medial state assessment module 122 determines a medial emotional phase state of the user by performing an aggregation of the plurality of emotional phase states captured over a period of time. Once the medial emotional phase state is determined, medial state assessment module 122 categorizes the medial emotional phase state of the user as one of a balance state, a bias state and a bipolar state. The categorization of the medial emotional phase state is then rendered to the user using a rendering module 124 using display 112 via the plurality of display modes in order to enable the user to become aware of the user's medial emotional state.

FIG. 2 illustrates analysis module 110 for identifying an emotional phase state corresponding to an emotional state of a user in accordance with an embodiment of the invention.

As illustrated in FIG. 2, analysis module 110 includes a valence assessment module 202, a phase assessment module 204 and a composite module 206. An emotional state of the user captured by data capture module 108 is analyzed using valence assessment module 202, phase assessment module 204 and composite assessment module 206 in order to determine the emotional phase state corresponding to the emotional state of the user.

Valence assessment module 202 performs a first assessment of the emotional state based on a valence state associated with the emotional state. The valence state can be either a positive valence state or a negative valence state.

Phase assessment module 204 performs a second assessment of the emotional state based on a phase and an angle associated with the emotional state.

Further, composite assessment module 206 performs a third assessment of the emotional state as a whole taking into account the valence state coordinates and the phase coordinates associated with the emotional state.

Thereafter, analysis module 110 determines the emotional phase state corresponding to the emotional state based on a phase coordinate and a valence coordinate on temporal phase topology framework 102 in accordance with the first assessment, the second assessment and the third assessment.

FIG. 3 illustrates various display modes to capture and display an emotional phase state of the user in accordance with an embodiment of the invention.

As illustrated in FIG. 3, a plurality of display modes includes a list/toroid side view 302, a planer circular view 304, a spherical view 306, a bipolar planer view 308 and a planer space view 310.

List/toroid side view 302, planer circular view 304, spherical view 306, bipolar planer view 308 and planer space view 310 display a capture mode and a display mode using display 112. The capture mode comprises a plurality of emotional states along with a valence associated with each emotional state of the plurality of emotional states. Further, the capture mode allows the user to select an emotional state along with a corresponding valence.

List/toroid side view 302 comprises a plurality of emotional states or phase states along with a valence listed from left to right. The capture mode of toroid side view 302 enables a user to select the various emotional states within a valence by vertical scrolling a list of emotional states from top to bottom or vice versa. Change in valence list or successive valence list is obtained by horizontal scrolling from left to right or vice versa.

Once the valence or the emotional state is selected, the display mode of toroid side view 302 displays the list of emotional states aligned with the central text displaying bias. In case of bipolar condition, the display mode displays the list of vertically oscillating emotional states.

Planer circular view 304 comprises a plurality of emotional states or phase states along with a valence represented on a circular map. The capture mode of planer circular view 304 enables a user to select the valence or the emotional state by providing a selector. The user may move or slide the selector along an emotional space or a valence space to select the valence or the emotional state.

The display mode of planer circular view 304 moves the selector to represent the selected emotional state or valence or slides the selector along with the emotional space or the valence space (region) on circular map to represent the selected emotional state. In another embodiment, a region comprising the selected emotional state or valence is highlighted.

Spherical view 306 comprises plurality of emotional states or phase states along with a valence represented on a spherical object. The capture mode of spherical view 306 enables a user to view the emotional states along with valence by moving the spherical object and provides a selector to select the emotional state or valence.

The display mode of spherical view 306 displays the selected valence or emotional state in the selector circle. Also, the spherical object is rotated in space to ensure the selection of the phase state or valence to be displayed in the selector circle.

Bipolar planer view 308 employs two circular maps corresponding to a positive valence and a negative valence. The plurality of emotional states or phases corresponding to positive valence are represented on a circular map of positive valence and a plurality of emotional states or phases corresponding to the negative valence are represented on a circular map of negative valence.

The capture mode of bipolar planer view 308 enables a user to select the valence or emotional state by providing a selector. The user may move or slide the selector along the emotional state or valence space to select the valence. The captured emotional state is then fed into analysis module 110.

The display mode of bipolar planer view 308 moves the selector to represent the selected emotional state or valence on a corresponding circular map or slides the selector along with an emotional space or a valence space (region) on corresponding circular map to represent the selected emotional state. In another embodiment, a region comprising selected emotional state or valence is highlighted.

Planer space view 310, on the other hand, comprises a plurality of emotional states or phase states along with a valence represented on a flat space view. The capture mode of planer space view 310 enables a user to select the valence or the emotional state by providing a selector. The user may move or slide the selector along an emotional space or a valence space to select the valence or the emotional state.

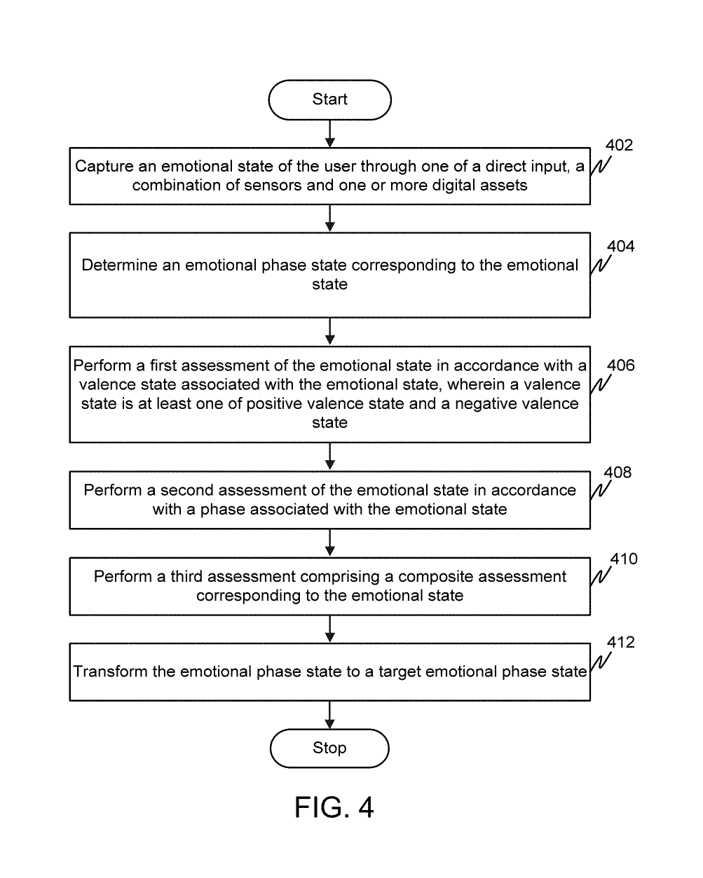

FIG. 4 illustrates a flowchart of a method for identifying and transforming emotional states of a user using temporal phase topology framework 102 in accordance with an embodiment of the invention.

At step 402, an emotional state of the user is captured through one of direct selection, a combination of sensors or one or more digital assets using data capture module 108. At step 404, an emotional phase state corresponding to the emotional state is identified using analysis module 110. An emotional phase state corresponds to a state location of an emotional state on temporal phase topology framework 102 represented by one of a phase coordinate and a valence coordinate.

In order to determine the emotional phase state, at step 406, a first assessment of the emotional state is performed in accordance with a valence state associated with the emotional state using analysis module 110. The valence state can be either a positive valence state or a negative valence state.

At step 408, a second assessment of the emotional state is performed in accordance with a phase associated with the emotional state using analysis module 110. Thereafter, at step 410, a third assessment of the emotional state is performed using analysis module 110. The third assessment includes a composite assessment corresponding to the emotional state.

Once the emotional phase state corresponding to the emotional state is identified, at step 412, the emotional phase state is transformed to a target emotional phase state using transformation module 114.

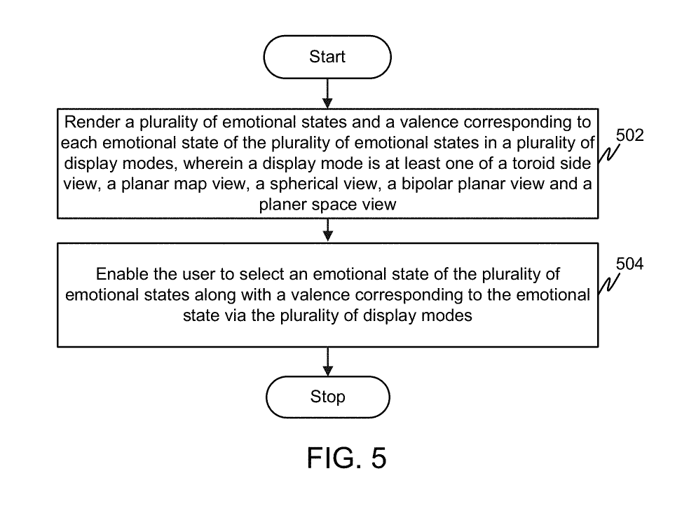

FIG. 5 illustrates a flowchart of a method for capturing and displaying an emotional phase state corresponding to an emotional of a user in accordance with an embodiment of the invention.

At step 502, a plurality of emotional states and a valence corresponding to each emotional state of the plurality of emotional states are rendered in a plurality of display modes using data capture module 108 and display 112. A display mode can be, but need not be limited to, a toroid side view, a planer view, a spherical view and a bipolar planer view.

Thereafter at step 504, for the direct capture of the emotional phase state, the user is enabled to select the emotional state of the plurality of emotional states along with the valence corresponding to the emotional state through the plurality of display modes via display 112.

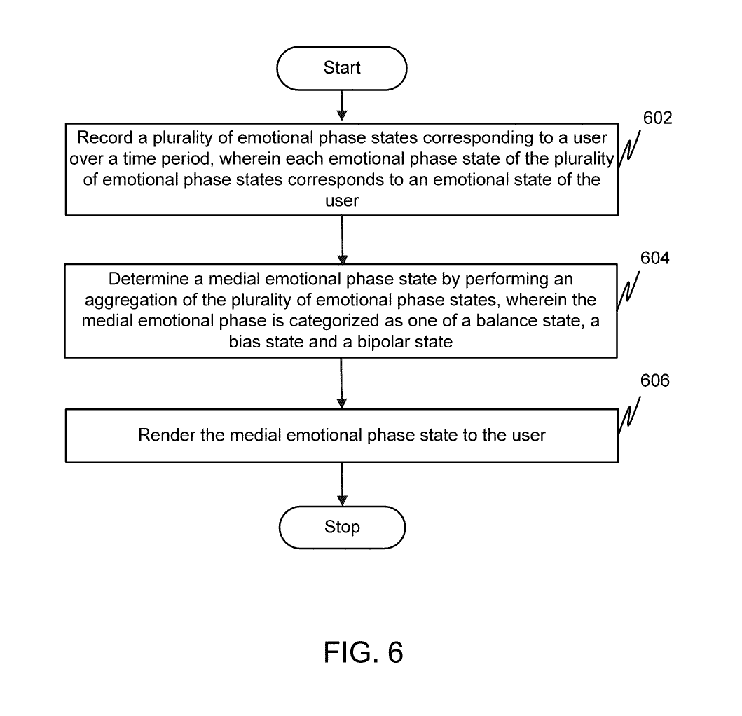

FIG. 6 illustrates a flowchart of a method for determining an aggregate or medial emotional tendencies of a user for emotional states of the user captured over a period of time using temporal phase topology framework 102 in accordance with an embodiment of the invention.

At step 602, plurality of emotional phase states corresponding to emotional states of the user is recorded for over a period of time using recording module 116.

At step 604, the aggregate medial emotional phase state or user mood is then determined by performing an aggregation of the plurality of emotional phase states using state assessment module 118. Thereafter, the medial emotional phase state is identified as one of a balance state, a bias state and a bipolar state. Further at step 606, the category of the medial emotional phase state is rendered to the user using display 112.

An embodiment of the present invention may relate to a computer program product with a non-transitory computer readable storage medium having computer code thereon for performing various computer-implemented operations of the method and/or system disclosed herein. The media and computer code may be those specially designed and constructed for the purposes of the method and/or system disclosed herein, or, they may be of the kind well known and available to those having skill in the computer software arts. Examples of computer-readable media include, but are not limited to, magnetic media, optical media, magneto-optical media and hardware devices that are specially configured to store and execute program code. Examples of computer code include machine code, such as produced by a compiler, and files containing higher-level code that are executed by a computer using an interpreter. For example, an embodiment of the present invention may be implemented using JAVA®, C++, or other object-oriented programming language and development tools. Aspects of the present invention may also be implemented using Hypertext Transport Protocol (HTTP), Procedural Scripting Languages and the like.

In accordance with an exemplary embodiment, temporal phase topology framework 102 is an application of the principles of non-linear dynamics to the area of emotional state identification, computation and transformation. A non-linear dynamical or chaotic system is characterized by ‘unpredictability’, which means simply that one cannot predict how a system will behave in the future on the basis of a series of observations along time. A chaotic system often alternates in a seemingly random way, but if its trajectories are depicted in a suitable graphical way, it is noticed that the repetitions tend to cluster in definite areas or groups of behaviors of the phase-space. Phase space can be depicted by a graph in two dimensions, showing two variables of the phenomenon.

Temporal phase topology framework 102, further, applies the principles of The Lorentz attractors & Malkus water wheel. Edward Lorenz developed a simplified mathematical framework for atmospheric convection based on three ordinary differential equations. The series does not form limit cycles nor does it ever reach a steady state hence it is an example of deterministic chaos. The physical reality of the irregular alternation circulation was substantiated when applied mathematicians Willem Malkus and Louis Howard, and Ruby Krishnamurti, built water wheels that were specifically intended to execute the behavior predicted by the three equations.

The key variables defining the motion of the water wheel are as under:

Q=Input water mass rate

λ=Cup leakage parameter

R=Radius where cups are located

I₀=Empty wheel moment of Inertia

α=Axle friction parameter

ω=Angular velocity

It may be observed that while Q and λ represent two opposing force vectors of flow of water (viz. one inward i.e. into the system and the other outward i.e. away from the system), I₀ and α represent two opposing force vectors of tangential to the system (viz. one in the direction of rotation and the other against it). The chaotic nature of motion of the water wheel is on account of the dynamic interplay of these two pairs of opposing force vectors at any point of time, which interact together as two complimentary pairs. Thus, while all force vectors act at all times, only one of the four at any point of time can be said to be the predominant cause of the subsequent movement. Based on the foregoing the phase space of the Lorenz attractors can be divided roughly into eight zones with one predominant force vector acting as the prime mover at a particular point of time.

Further, temporal phase topology framework 102 applies the principles of non-linear dynamics in neuronal activity. From various experiments, it has been well established that neuronal activity and electroencephalograph recordings (EEG) show characteristics of chaotic behavior, in other words, the overall system which gives origin to the potentials of the EEG, namely the brain, is in a chaotic state. For example, Freeman and colleagues have developed mathematical frameworks for EEG signals generated by the olfactory system in rabbits. These investigators have suggested that the learning and recognition, as well as the recall can be explained through chaotic dynamics. The background chaotic activity enables the system to jump rapidly into different phases when presented with the appropriate input. “The transition back and forth between the wings or between the central part and one wing stands for phase transition in the sense of physics and for pattern recognition in the sense of neural networks” (Freeman 1990).

The theory of dynamical systems and its connections with other fields of neuroscience, more recently with self-organization and emergence of new patterns in the so-called complex systems is gaining recognition. The theory has proven successful for dealing with, for example, neural circuits, the control of movement, language, perception and action, cognition and operations leading to decision-making. This chaotic and fractal nature of the entire field of human physiology has been well documented by Goldberger, Rigney and West in their paper “Chaos & Fractals in Human Physiology.

Temporal phase topology framework 102 incorporates a Lorenz graph for categorizing emotional states of the user.

With reference to the Lorenz graph, at any position of buckets, the key dynamical parameters acting on each bucket is a combination of the following:

### I₀=Rotational Inertia

### α=Rotational Damping Rate

Q=Inflow rate, and
λ=Leakage rate

Various categories of emotional states of temporal phase topology framework 102 include Heavy (H), Expressive (E), Aware (A) and Lucid (L). The relational parameters in the emotional space would then follow the correspondence as under:

I₀=Rotational Inertia relates to influence of Heavy state emotions,
α=Rotational Damping Rate relates to Lucid state emotions,
Q=Inflow Rate relates to Aware emotional state, and
λ=Leakage Rate relates to Expressive state emotions.
The motion of the water wheel would be then affected by the dynamically changing the above parameter values.

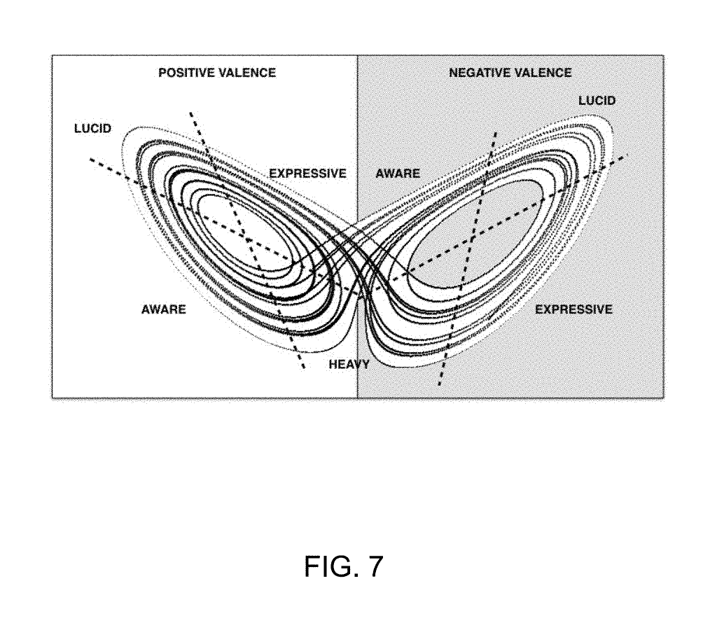

FIG. 7 illustrates the Lorenz Graph employed by temporal phase topology framework 102 as applied to emotional state vectors in accordance with an embodiment of the invention.

As illustrated in FIG. 7, complimentary measures of Heavy and Lucid categories are along one axis and those of Aware and Expressive categories are along the other axes. Further, in temporal phase topology framework 102, the two strange attractors of the Lorenz graph are aligned along the positive and negative valence axes.

Further, in both valence polarities, at any point on the Lorenz graph, based on its quadrant location, there would be a predominant influence of one of the four parameters. The identified parameter would result into the user experiencing that related emotional state at that juncture.

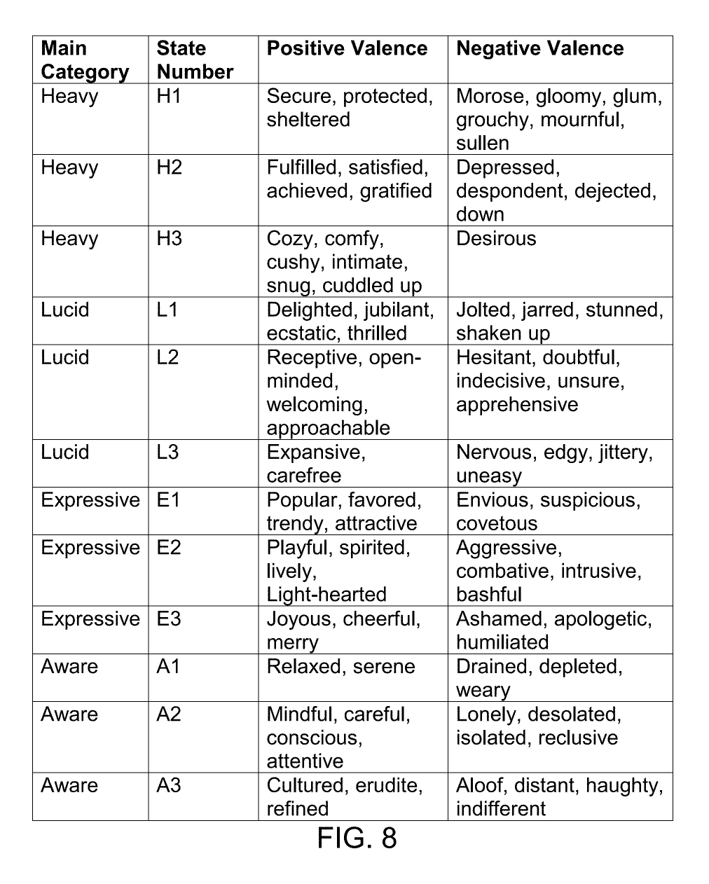

FIG. 8 illustrates a table of various emotional states associated with positions along the various points within the four phases of the Lorenz graph employed by temporal phase topology framework 102. The temporal phase topology framework of the present invention includes a plurality of emotional states categorized into a plurality of emotional phase states. An emotional phase state corresponds to a state location of an emotional state on the temporal phase topology framework represented by a phase coordinate and a valence coordinate.

As illustrated in FIG. 8, the various emotional states are categorized into 12 categories within each valence sub-category and associated with a state number for each category. For example, the state numbers for Heavy are H1, H2 and H3, for Lucid are L1, L2 and L3, for Aware A1, A2 and A3 and for Expressive are E1, E2 and E3.

Further, the various states within Heavy-Lucid and Aware-Expressive axes can also be represented in an angular system, replacing the X and Y coordinates by a single angle improving the flexibility of the temporal phase topology framework 102.

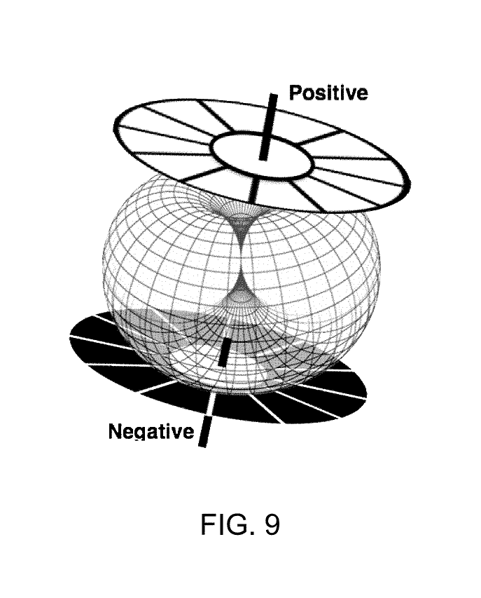

Also, temporal phase topology framework 102 can be easily transposed onto a three dimensional toroid framework with the positive and negative valances representing the polar axes and the maps can then be represented two dimensionally as circular planes, one for each valence as illustrated in FIG. 9.

Temporal phase topology framework 102 then captures an emotional state of a user by rendering a plurality of emotional states corresponding to each emotional state of the plurality of emotional states using a plurality of display modes.

Further, temporal phase topology framework 102 determines an emotional phase state associated with an emotional state by analyzing a phase state location of the emotional state in the categories corresponding to the emotional states as represented in the three dimensional topology. Temporal phase topology framework 102, then, either aggregates or transforms the emotional phase state into a target emotional phase state.

Thereafter, based on the target emotional phase state, temporal phase topology framework 102 recommends one or more activities pertaining to selection of a suitable stimulus for enabling the user to move towards a greater emotional or attitudinal balance.

Consider a scenario where a user selects an emotional state with a negative emotion and selects the emotion phase state through one of the suggested display modes of the temporal phase topology framework 102. Data capture module 108 captures an emotional state of the user corresponding to the negative emotion. The emotional state captured by data capture module 108 is then fed into analysis module 110. Analysis module 110 performs a valence assessment, a phase assessment and a composite assessment of the emotional state of the user in order to determine an emotional phase state corresponding to the emotional state of the user. The emotional phase state thus determined occupies a state or location in the negative valence of temporal phase topology framework 102. The emotional phase state is then transformed into another emotional phase state corresponding to a positive emotional state that occupies a state or location in the positive valence of temporal phase topology framework 102 using transformation module 114. Recommendation module 116, then, selects one or more stimuli corresponding to the transformed emotional phase state. Hence, in the case of the emotional phase state in the negative valence, recommendation module 116 provide a suitable option to the user in order to effect a change into the positive valence state by selecting a suitable stimulus.

In accordance with another scenario, recording module 120 of temporal phase topology framework 102 records a set emotional phase states of the user for a given period of time. Each emotional phase state in the set of emotional phase states occupy either a positive valence state or a negative valence state in temporal phase topology framework 102. Medial state assessment module 122 determines a medial emotional phase state or mood of the user by performing an aggregation of the set of emotional phase states and categorizes the medial emotional phase state or mood of the user as one of a balance state, a bias state and a bipolar state. For example, the medial emotional phase state is categorized as a balance state if state assessment module 122 determines that the emotional states of the user have maintained a balance across different emotional phase states in both the positive and negative valence states for the given period of time. The medial emotional phase state is categorized as a bias state if medial state assessment module 122 determines that the emotional states of the user have been predominately occupying a specific emotional phase state for the given period of time. The medial emotional phase state is categorized as a bipolar state if medial state assessment module 122 determines that the emotional states of the user have been oscillating between two or more oppositional emotional phase states for the given period of time.

The invention utilizes a temporal phase topology framework, which can be used to identify a user's reactionary bias to one or more personal events or memories and to suggest or recommend stimuli to enable the user to move towards greater attitudinal/emotional balance. In case of a negative emotional state of the user, the temporal phase topology framework suggests one or more stimuli choices to enable the user to move away from the negative mood/emotional state to re-establish emotional harmony.

Further, the temporal phase topology framework not only provides ease of visualization but also provides a framework for assessing the relationships between various emotional states from both combinatory and temporal perspectives for identification of a balance state, a bias state and a bipolar state in order to create an awareness to the user pertaining to the user's emotional state transitions. Further, as the emotional states are categorized, a calculation of balance or biases is only an assessment of the equilibrium amongst the vectors acting in the framework. Thus, the framework is highly efficient in design as it preserves three-dimensional symmetry and is also efficient since the negative and positive states do not occur in separate phases but are only a result of reverse angular directions.

Thus, the space modeling of emotional states in the temporal phase topology framework is not only efficient for visualization but also enables comprehensive analysis of various states for identification of balance, bias and bipolar scenarios for aggregated data points. Since the trajectory of a point in Lorenz space is bound to oscillate around the two strange attractors, the framework has temporal properties. Hence, it is possible to alter the trajectory if an input that will effect a change of an adjacent parameter value by altering the vector equilibrium of a point in the system.

Thus, the fourfold benefits of the temporal phase topology framework include a) its temporal/sequencing ability for effecting transformation, b) its aggregating ability for determining balance, bias or bipolar attitudes, c) its three dimensional symmetry across phases and valences facilitating rendering for capture and display and d) its ability to categorize stimuli based on the same framework for effecting coherent transformation.

Those skilled in the art will realize that the above recognized advantages and other advantages described herein are merely exemplary and are not meant to be a complete rendering of all of the advantages of the various embodiments of the invention.

The system, as described in the invention or any of its components may be embodied in the form of a computing device. The computing device can be, for example, but not limited to, a general-purpose computer, a programmed microprocessor, a micro-controller, a peripheral integrated circuit element, and other devices or arrangements of devices, which are capable of implementing the steps that constitute the method of the invention. The computing device includes a processor, a memory, non-volatile data storage, a display, and a user interface.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for identifying emotional states of a user using a temporal phase topology framework, wherein the temporal phase topology framework comprises a plurality of emotional states categorized into a plurality of emotional phase states, wherein an emotional phase state corresponds to location of an emotional state on the temporal phase topology framework represented by one of a phase coordinate and a valence coordinate, the method comprising:
capturing, by one or more processors, an emotional state of the user through at least one of a direct selection, a combination of sensors and one or more digital assets; and
determining, by one or more processors, an emotional phase state corresponding to the emotional state, wherein determining the emotional phase state comprises:
performing, by one or more processors, a first assessment of the emotional state in accordance with a valence state associated with the emotional state, wherein a valence state is at least one of a positive valence state and a negative valence state;
performing, by one or more processors, a second assessment of the emotional state in accordance with a phase associated with the emotional state; and
performing, by one or more processors, a third assessment comprising a composite assessment corresponding to the emotional state.

2. The method according to claim 1, wherein a digital asset is at least one of a video file, an audio file and an image file.

3. The method according to claim 1 further comprises capturing, by one or more processors, an emotional phase state corresponding to an emotional state of a user by:
rendering, by one or more processors, a plurality of emotional states and a valence corresponding to each emotional state of the plurality of emotional states in a plurality of display modes, wherein a display mode is at least one of a toroid side view, a planer map view, a spherical view, a bipolar planer view and a planer space view; and
enabling, by one or more processors, the user to select an emotional state of the plurality of emotional states along with a valence corresponding to the emotional state via the plurality of display modes.

4. The method according to claim 1 further comprises transforming, by one or more processors, an emotional phase state to a target emotional phase state.

5. The method according to claim 4, wherein transforming, by one or more processors, an emotional phase state further comprises recommending, by one or more processors, at least one stimulus from a stimuli database in accordance with the target emotional phase state.

6. The method according to claim 5, wherein a stimulus is at least one of a mental, an auditory, a tactile, a kinesthetic, an olfactory, a visual and a gustatory input.

7. The method according to claim 5, wherein a stimuli database comprises a plurality of stimuli, wherein each stimulus is categorized as per the temporal phase topology framework into at least one or more phase states.

8. The method according to claim 5, wherein a stimulus is provided to a user by at least one of a visual input and an auditory input and a recommendation of at least one activity that the user can perform corresponding to the stimulus.

9. The method according to claim 5 further comprises enabling, by one or more processors, the user to provide a feedback based on an experience of the stimulus, wherein the feedback is utilized for adjusting a phase set of the stimulus to provide an effective categorization of the stimulus for subsequent utilization by the user.

10. The method according to claim 1 further comprises:
recording, by one or more processors, a plurality of emotional phase states over a time period, wherein each emotional phase state of the plurality of emotional phase states corresponds to an emotional state of the user;
determining, by one or more processors, a medial emotional phase state by performing an aggregation of the plurality of emotional phase states, wherein the medial emotional phase state is categorized as one of a balance state, a bias state and a bipolar state; and
rendering, by one or more processors, the medial emotional phase state to the user.

11. A system for identifying emotional states of a user using a temporal phase topology framework, wherein the temporal phase topology framework comprises a plurality of emotional states categorized into a plurality of emotional phase states, wherein an emotional phase state corresponds to a location of an emotional state on the temporal phase topology framework represented by one of a phase coordinate and a valence coordinate, the system comprising:
a memory;
a processor communicatively coupled to the memory, wherein the processor is configured to:
capture an emotional state of the user through at least one of a direct selection, a combination of sensors and one or more digital assets; and
determine an emotional phase state corresponding to the emotional state, wherein the processor is configured to determine the emotional phase state by:
performing a first assessment of the emotional state in accordance with a valence state associated with the emotional state, wherein a valence state is at least one of a positive valence state and a negative valence state;
performing a second assessment of the emotional state in accordance with a phase associated with the emotional state; and
performing a third assessment comprising a composite assessment corresponding to the emotional state.

12. The system according to claim 11, wherein the processor is further configured to capture an emotional phase state corresponding to an emotional state of a user by:
rendering a plurality of emotional states and a valence corresponding to each emotional state of the plurality of emotional states in a plurality of display modes, wherein a display mode is at least one of a toroid side view, a planer map view, a spherical view, a bipolar planer view and a planer space view; and
enabling the user to select an emotional state of the plurality of emotional states along with a valence corresponding to the emotional state via the plurality of display modes.

13. The system according to claim 11, wherein the processor is further configured to transform an emotional phase state to a target emotional phase state.

14. The system according to claim 13, wherein the processor is further configured to transform an emotional phase state by recommending at least one stimulus from a stimuli database using the temporal phase topology framework in accordance with the target emotional phase state.

15. The system according to claim 11, wherein the processor is further configured to:
record a plurality of emotional phase states corresponding to a user over a time period, wherein each emotional phase state of the plurality of emotional phase states corresponds to an emotional state of the user;
determine a medial emotional phase state by performing an aggregation of the plurality of emotional phase states, wherein the medial emotional phase state is categorized as one of a balance state, a bias state and a bipolar state; and
render the medial emotional phase state to the user.

16. A computer program product for identifying emotional states of a user using a temporal phase topology framework, wherein the temporal phase topology framework comprises a plurality of emotional states categorized into a plurality of emotional phase states, wherein an emotional phase state corresponds to a location of an emotional state on the temporal phase topology framework represented by one of a phase coordinate and a valence coordinate, the computer program product comprising a non-transitory computer readable storage medium having program instructions stored therein, the program instructions readable/executable by a processor to cause the processor to:
capture an emotional state of the user through at least one of a direct selection, a combination of sensors and one or more digital assets; and
determine an emotional phase state corresponding to the emotional state, wherein an emotional phase state corresponds to a phase state location of an emotional state on the temporal phase topology framework, wherein the program instructions cause the processor to determine the emotional phase state by:
performing a first assessment of the emotional state in accordance with a valence state associated with the emotional state, wherein a valence state is at least one of a positive valence state and a negative valence state;
performing a second assessment of the emotional state in accordance with a phase associated with the emotional state; and
performing a third assessment comprising a composite assessment corresponding to the emotional state.

17. The computer program product according to claim 16, wherein the program instructions further cause the processor to capture an emotional phase state corresponding to an emotional state of a user:
rendering a plurality of emotional states and a valence corresponding to each emotional state of the plurality of emotional states in a plurality of display modes, wherein a display mode is at least one of a toroid side view, a planer map view, a spherical view, a bipolar planer view and a planer space view; and
enabling the user to select an emotional state of the plurality of emotional states along with a valence corresponding to the emotional state via the plurality of display modes.

18. The computer program product according to claim 16, wherein the program instructions further cause the processor to transform an emotional phase state to a target emotional phase state.

19. The computer program product according to claim 18, wherein the program instructions further cause the processor to transform an emotional phase state by recommending at least one stimulus from a stimuli database using the temporal phase topology framework in accordance with the target emotional phase state.

20. The computer program product according to claim 16, wherein the program instructions further cause the processor to:
record a plurality of emotional phase states corresponding to a user over a time period, wherein each emotional phase state of the plurality of emotional phase states corresponds to an emotional state of the user;
determine a medial emotional phase state by performing an aggregation of the plurality of emotional phase states, wherein the medial emotional phase state is categorized as one of a balance state, a bias state and a bipolar state; and
render the medial emotional phase state to the user.
